(19) United States
(12) Patent Application Publication
(10) Pub. No.: US 2010/0156601 A1
(43) Pub. Date: Jun. 24, 2010

(54) LLRP-Based Flexible Reader System And Method

(76) Inventors: Lang LIN, Potomac, MD (US); Hugo Molina, Germantown, MD (US); Ping Zhu, Germantown, MD (US)

Correspondence Address: MOTOROLA, INC., 1303 EAST ALGONQUIN ROAD, IL01/3RD, SCHAUMBURG, IL, 60196, US

(21) Appl. No.: 12/341,607

(22) Filed: Dec. 22, 2008

(51) Int. Cl. H04Q 5/22

(52) U.S. Cl. 340/10.1

(57) ABSTRACT

A system includes a host computing device, a first RFID transceiver, and at least one second RFID transceiver. The host computing device executes an application according to a predetermined RFID communication protocol. The predetermined RFID communication protocol supports communication only with a single RFID transceiver. The first RFID transceiver communicates with the host computing device according to the predetermined RFID communication protocol. The at least one second RFID transceiver communicates with the first RFID transceiver. The at least one second RFID transceiver provides data to the host computing device only via the first RFID transceiver.

### BACKGROUND

System deployments employing radio frequency identification (“RFID”) frequently include multiple RFID readers. Operations of multiple readers must be coordinated to insure proper operation. An RFID switch is often used for this purpose. However, the inclusion of an RFID switch adds cost and complexity to a multi-reader RFID deployment.

Many RFID readers operate using Low Level Reader Protocol (“LLRP”), a protocol developed and ratified to standardize data handling in order for applications to control a single RFID reader. This protocol is commonly supported but has two drawbacks. First, LLRP only supports operations involving a single RFID reader. Second, LLRP offers limited configuration options. Thus, while LLRP is a useful standard, it is not universally applicable.

### SUMMARY OF THE INVENTION

The present invention is directed to a system including a host computing device, a first RFID transceiver and at least one second RFID transceiver. The host computing device executes an application according to a predetermined RFID communication protocol. The predetermined RFID communication protocol supports communication only with a single RFID transceiver. The first RFID transceiver communicates with the host computing device according to the predetermined RFID communication protocol. The at least one second RFID transceiver communicates with the first RFID transceiver. The at least one second RFID transceiver provides data to the host computing device only via the first RFID transceiver.

The present invention is further directed to a method including receiving receiving, by a first RFID transceiver, data from at least one second RFID transceiver; and sending, by the first RFID transceiver, the received data to a host computing device according to a predetermined RFID communication protocol. The predetermined RFID communication protocol supports communication only with a single RFID transceiver. The at least one second RFID transceiver provides data to the host computing device only via the first RFID transceiver.

The present invention is further directed to a computer readable storage medium including a set of instructions executable by a processor. The instructions are operable to receive data, by a first RFID transceiver, from at least one second RFID transceiver. The instructions are further operable to send the data, by the first RFID transceiver, to a host computing device according to a predetermined RFID communication protocol. The predetermined RFID communication protocol supports communication only with a single RFID transceiver. The host computing device receives data from the at least one second RFID transceiver only via the first RFID transceiver.

### BRIEF DESCRIPTION OF THE DRAWINGS

FIG. 1 shows an exemplary embodiment of a system including a plurality of RFID readers according to the present invention.

FIG. 2 shows an exemplary embodiment of a method for relaying data to a host computing device according to the present invention.

FIG. 3 shows an exemplary embodiment of a method for initiating communications with a host computing device according to the present invention.

### DETAILED DESCRIPTION

The exemplary embodiments of the present invention may be further understood with reference to the following description and the appended drawings, wherein like elements are referred to with the same reference numerals. The exemplary embodiments describe systems and methods for relaying data to a host computing device using an RFID reader rather than using an RFID switch with dedicated software.

Many users of RFID systems are business entities with installations including multiple RFID readers. These readers may be used for various purposes including tracking devices with RFID transponders, reading information from such transponders, writing information to the transponders, etc. In order for data to be properly routed to and from the receivers, their operations must be coordinated.

An application operating using LLRP may support multiple RFID readers. Further, because LLRP is a standard protocol, major software vendors support it. However, due to the above-described deficiencies of LLRP, hardware and software dedicated to the purpose of coordinating multiple RFID readers are required. This adds complexity to a deployment and cost to the user.

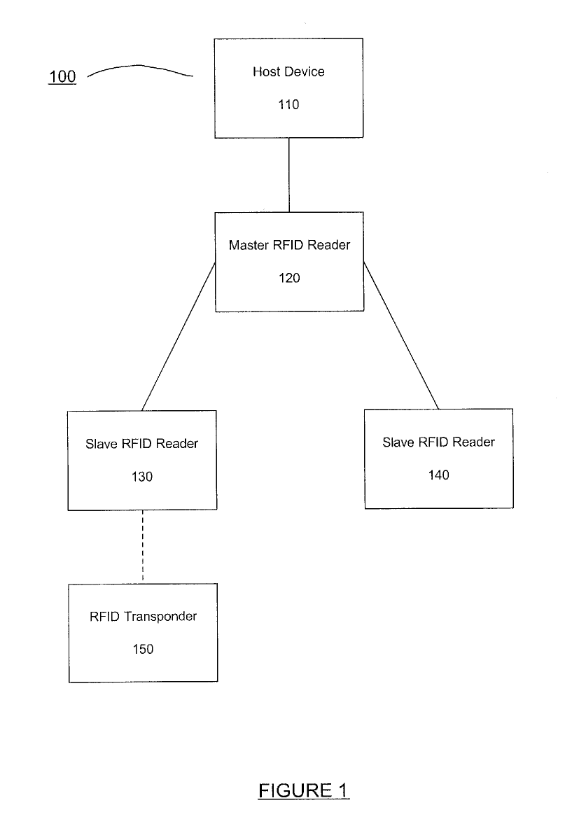

FIG. 1 shows an exemplary embodiment of a system 100 according to the present invention that includes a plurality of RFID readers operating under the control of a single LLRP application. The system 100 may include a host device 110 that executes the LLRP application. The host device 110 may be a fixed or mobile computer, a data server, a scanner, an imager, a database, or any other device capable of operating such an application. The application may be one of any of the various types commonly using RFID readers, such as inventory tracking, electronic funds transfer, etc. Specific data read by an RFID reader may be, but is not limited to, RFID tag identifiers, time stamps, product identifiers, product serial numbers, product manufacturing dates and product transaction data.

The system 100 may also include a first RFID reader 120 that communicates with the host device 110 according to the LLRP protocol. The first reader 120 (which will also be referred to as the “master reader 120”) may be located in close proximity to the host device 110 or may be located remotely and communicate with the host device 110 using any of the various networking techniques that are known in the art, either wired or wirelessly. The functions performed by the first reader 120 are in accordance with the LLRP application being run by the host device 110; thus, they may vary as the host device 110 may terminate one LLRP application and execute another. The master reader 120 may be, for example, a fixed or handheld RFID reader, a scanner, an imager, or may be part of a multipurpose device that is also adapted to carry out unrelated tasks.

The system 100 may further include a plurality of further RFID readers. While the exemplary system 100 is described with reference to two further RFID readers 130 and 140 (hereinafter also referred to as “slave readers 130 and 140”), those of skill in the art will understand that the number of readers may vary among different RFID deployments, and that the illustration of two slave RFID readers and three total RFID readers is only exemplary. The slave readers 130 and 140 may be the same model of reader as the master reader 120 or may be another type of LLRP-compatible reader. Alternately, the slave readers 130 and 140 may be virtual entities such as ensembles of antennas. In such embodiments, an ensemble of antennas may be freely picked up based on spatial location and available time slot. As above, the functions performed by the slave readers 130 and 140 correspond to the LLRP application executed by the host device 110, and may vary if the host device 110 executes a new LLRP application. In one embodiment, there may be one master reader and three slave readers, each of which utilizes four antennas; functionally, this system would perform as a single reader with sixteen antennas. It should be noted that while FIG. 1 illustrates a hierarchical view of the system 100, in which the host device 110 may communicate only with the master reader 120, and the master reader 120 with the slave readers 130 and 140, the readers may alternately be components of a network that is visible to the host device. Further, the slave readers 130 and 140 may be capable of acting as nested sub-master readers, relaying data from further sub-slave readers to the master reader 120.

The slave readers 130 and 140 communicate directly with the master reader 120, and only indirectly with the host device 110, as the LLRP standard enables the host device 110 to communicate with only a single LLRP-compatible reader. When the slave readers receive a signal, such as from an RFID transponder 150 (also known as a “tag”), information is relayed to the host device 110 via the master reader 120. The host device 110, which is capable of communicating solely with one reader, is unaware that the data was received by one of the slave readers. The host device 110 may then act on the data (e.g., in accordance with an LLRP-compatible application). If a response is required, the host device 110 sends such response to the master reader 120, which then relays it to the applicable slave reader 130 or 140. Thus, the slave readers 130 and 140 may function in substantially the same manner as the master reader 120 that communicates directly with the host device 110.

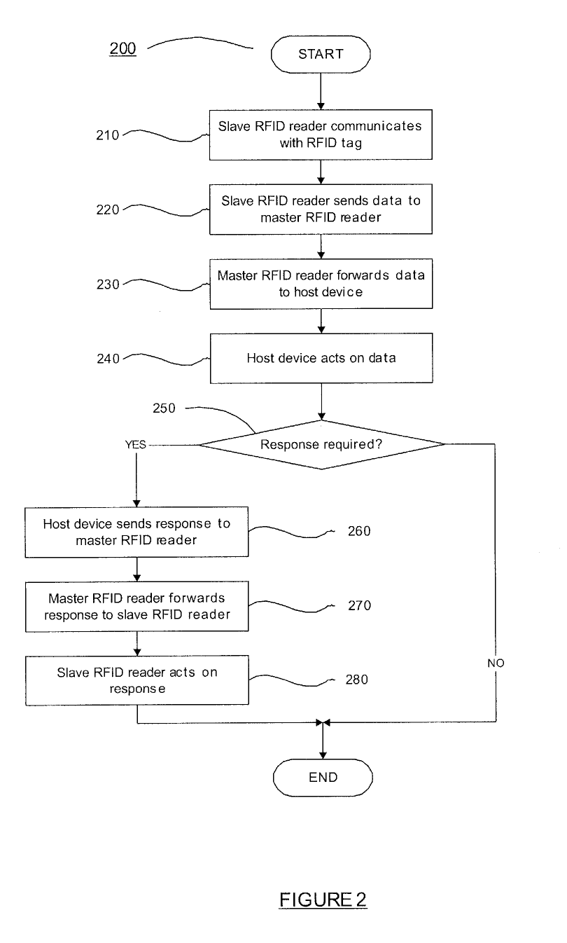

FIG. 2 shows an exemplary embodiment of a method 200 according to the present invention. While the method 200 will be described with reference to the system 100 of FIG. 1, those of skill in the art will understand that the method 200 may also be performed by different systems capable of such performance. In step 210, a slave reader (e.g., reader 130 or 140) communicates with an RFID tag (e.g., the RFID tag 150) and receives data therefrom. The data may be of any type typically read by standard RFID arrangements. In step 220, the slave reader 130 or 140 sends the data to the master reader (e.g., the reader 120). The master reader 120 then forwards the data to the host device (e.g., the device 110) in step 230. It should be noted that the host device 110 may be unable to distinguish between data that has been read from an RFID transponder by the master reader 120 and data that has been forwarded from the slave reader 130 or 140 by the master reader 120, in accordance with the LLRP protocol.

In step 240, the host device 110 acts on the received data in a manner dictated by the LLRP-compatible application it is executing, as described above. For example, this may include looking up further information relating to the received data, storing information (e.g., in a log, database, etc.) relating to the received data, etc. In step 250, the host device 110 determines whether a response is required to the data that was received. As above, such a response will be in accordance with the application being executed by the host device 110.

If a response is required, then in step 260, the host device 110 prepares such a response and sends it to the master RFID reader 120 in accordance with the LLRP protocol. As above, the host device 110 may remain unaware that the response will be relayed to a further RFID reader. In step 270, the master RFID reader 120 forwards the response to the slave RFID reader 130 or 140 from which the data originated. Finally, in step 280, the slave RFID reader 130 or 140 acts on the response in an appropriate manner (e.g., forwards the response to the RFID tag 150 from which it received the original data, etc.). Following step 280, the method terminates. Alternately, if the host device 110 determines in step 250 that no response is required, the method terminates at that point.

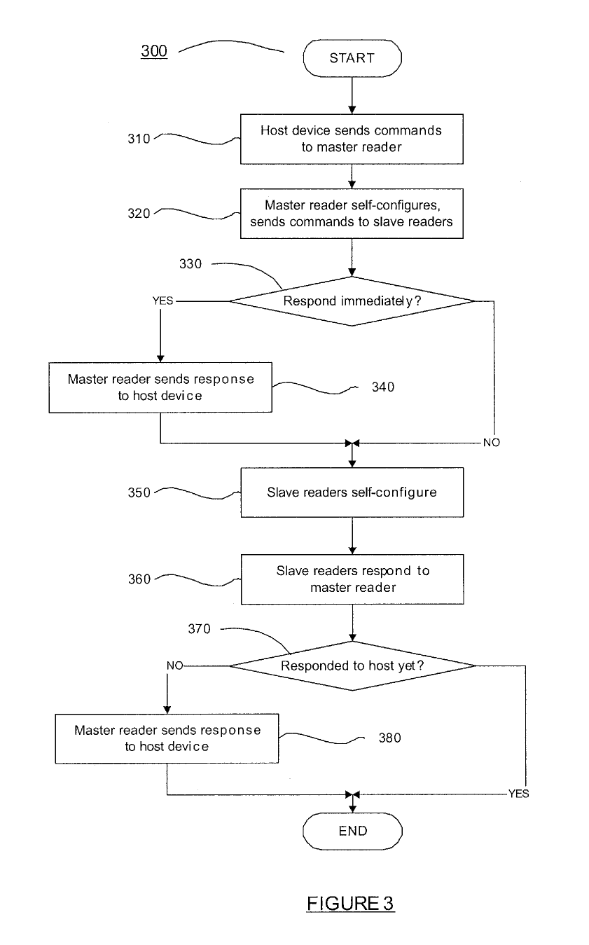

FIG. 3 illustrates an exemplary method 300 by which communications between the host device 110 and the RFID readers may be initialized. As for the method 200, the method 300 will be described with reference to the system 100, but those of skill in the art will understand that it may also be performed by various other arrangements of components including at least one host device and two RFID readers. In step 310, the host device 110 sends configuration or management commands to the master reader 120. Commands may be any suitable commands known in the art for configuring RFID readers. The determination of which of a group of readers will serve as the master reader may be made in a number of different ways. In one method, the master reader 120 may be predetermined and hardwired to act as such; in this case, the master reader 120 is different from all other readers. In another, the master reader may be determined based on a predetermined protocol, and all readers may be eligible to become the master on this basis; for example, the host device 110 may send a request (e.g., to a group of readers in a network as described above) for a master reader, and the first reader to respond may become the master reader 120. In a further method, all readers may be eligible to be the master reader 120, but the host may select one (e.g., by IP address or MAC address).

In step 320, the master reader 120 configures itself in accordance with the commands received in step 310 and forwards the commands to the slave readers 130 and 140. Commands may be forwarded as they were received or may be modified to reflect the master/slave reader arrangement. In step 330, the master reader 120 determines whether to respond to the host device 110 immediately, or to respond after receiving responses from the slave readers 130 and 140. This determination may be made based on a variety of factors. In some exemplary embodiments, the master reader 120 may determine a time for response based on requirements of the LLRP protocol; in others, it may be based on the configuration of the master reader 120 and the slave readers 130 and 140 (e.g., hard wired, part of a network, etc.). If the master reader 120 determines that an immediate response is appropriate, then in step 340 a response corresponding to the instructions sent by the host device 110 is returned. After this step, or if the master reader 120 determines that a later response is appropriate, the method continues to step 350.

In step 350, the slave readers 130 and 140 configure themselves in accordance with the instructions sent in step 320. Configuration may be similar to that performed by the master reader 120, but may typically configure the slave readers 130 and 140 so that they may send read data to the master reader 120 rather than the host device 110 in accordance with the principles of the exemplary embodiments. In step 360, the slave readers 130 and 140 respond to the master reader 120 to inform it that configuration has been completed. In step 370, the master reader determines whether it previously responded to the host device 110 in step 340. If not, then in step 380, it sends a response, similar to that described above for step 340, to the host device 110 informing it that configuration is complete. After step 380, or if the master reader 120 responded to the host device 110 previously, the method terminates.

Thus, the above-described exemplary embodiments of the present invention may enable an RFID implementation to utilize software developed according to the LLRP standard and multiple RFID readers. One of the advantages of the present invention is that no RFID switch or dedicated switching software may be required. Another advantage of the present invention is that the cost and complexity of such RFID systems may be reduced.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A system, comprising:
a host computing device executing an application according to a predetermined RFID communication protocol, the predetermined RFID communication protocol supporting communication only with a single RFID transceiver;
a first RFID transceiver communicating with the host computing device according to the predetermined RFID communication protocol; and
at least one second RFID transceiver communicating with the first RFID transceiver,
wherein the at least one second RFID transceiver provides data to the host computing device only via the first RFID transceiver.

2. The system of claim 1, wherein the host computing device provides response data to the second RFID transceiver only via the first RFID transceiver.

3. The system of claim 1, wherein the data is one of an RFID tag identifier, a time stamp, a product identifier, a product serial number, a product manufacturing date and a product transaction data.

4. The system of claim 2, wherein the response data is one of a command and a parameter value.

5. The system of claim 2, wherein the response data corresponds to the data.

6. The system of claim 1, wherein the second RFID transceiver receives the data from an RFID transponder.

7. The system of claim 1, wherein the first RFID transceiver is one of fixed and handheld.

8. The system of claim 1, wherein the second RFID transceiver is one of a fixed RFID transceiver, a handheld RFID transceiver and an antenna array.

9. A method, comprising:
receiving, by a first RFID transceiver, data from at least one second RFID transceiver; and
sending, by the first RFID transceiver, the received data to a host computing device according to a predetermined RFID communication protocol, the predetermined RFID communication protocol supporting communication only with a single RFID transceiver,
wherein the at least one second RFID transceiver provides data to the host computing device only via the first RFID transceiver.

10. The method of claim 9, further comprising:
receiving, by the first RFID transceiver, response data from the host computing device; and
sending, by the first RFID transceiver, the response data to the at least one second RFID transceiver.

11. The method of claim 10, wherein the response data corresponds to the data.

12. The method of claim 9, wherein the at least one second RFID transceiver receives the data from an RFID transponder.

13. The method of claim 9, wherein the data is one of an RFID tag identifier, a time stamp, a product identifier, a product serial number, a product manufacturing date and a product transaction data.

14. The method of claim 10, wherein the response data is one of a parameter value and a command.

15. The method of claim 9, wherein the first RFID transceiver is one of fixed and handheld.

16. The method of claim 9, wherein the second RFID transceiver is one of a fixed RFID transceiver, a handheld RFID transceiver, and an antenna array.

17. A computer readable storage medium including a set of instructions executable by a processor, the instructions operable to:
receive data, by a first RFID transceiver, from at least one second RFID transceiver;
send the data, by the first RFID transceiver, to a host computing device according to a predetermined RFID communication protocol, the predetermined RFID communication protocol supporting communication only with a single RFID transceiver,
wherein the host computing device receives data from the at least one second RFID transceiver only via the first RFID transceiver.
